(19) United States
(12) Patent Application Publication
(10) Pub. No.: US 2020/0386320 A1
(43) Pub. Date: Dec. 10, 2020

(54) SEAL ARRANGEMENT

(71) Applicant: Carl Freudenberg KG, Weinheim (DE)

(72) Inventors: Frank Lauer, Rauenberg (DE); Christian Kohl, Weinheim (DE); Thomas Kramer, Rimbach (DE)

(21) Appl. No.: 16/955,080

(22) PCT Filed: Dec. 12, 2018
(86) PCT No.: PCT/EP2018/084459

§ 371 Date: Jun. 18, 2020

(30) Foreign Application Priority Data
Dec. 21, 2017 (DE) 10 2017 011 929.5

(51) Int. Cl. F16J 15/56; F16J 15/3208; F16J 15/322; F16J 15/3248

(52) U.S. Cl. CPC F16J 15/56; F16J 15/3248; F16J 15/322; F16J 15/3208

(57) ABSTRACT

A seal arrangement includes: a first sealing element, which is radially pre-loaded and rests against and seals a machine element; and a second sealing element, which is arranged concentrically to the first sealing element and radially presses the first sealing element against the machine element. The first sealing element and the second sealing element are received in a housing bore of a housing. The first sealing element and the second sealing element seal a gap between the housing bore and the machine element. The first sealing element and the second sealing element are flat in a radial plane, at least on an end face facing a space to be sealed, and aligned with each other.

### CROSS-REFERENCE TO PRIOR APPLICATIONS

This application is a U.S. National Phase application under 35 U.S.C. § 371 of International Application No. PCT/EP2018/084459, filed on Dec. 12, 2018, and claims benefit to German Patent Application No. DE 10 2017 011 929.5, filed on Dec. 21, 2017. The International Application was published in German on Jun. 27, 2019 as WO 2019/121190 under PCT Article 21(2).

### FIELD

The invention relates to a seal arrangement comprising a first sealing element, which is radially pre-loaded and rests against and seals a machine element, and a second sealing element, which is arranged concentrically to the first sealing element and radially presses the first sealing element against the second machine element, wherein the first sealing element and the second sealing element are received in a housing bore.

### BACKGROUND

Seal arrangements of this type are known from general mechanical engineering and are used, for example, as rod seals or piston seals for sealing machine elements that undergo translational movement. In such cases, the first sealing element rests against the machine element, wherein the first sealing element is radially pressed against the machine element by a second sealing element, which is arranged on the outer circumference on the first machine element and radially presses the first sealing element against the machine element. In this case, the first sealing element frequently consists of a polymeric material with a proportionally low elasticity, while the second sealing element frequently consists of an elastomeric material. For example, using an 0-ring as the second sealing element is known.

In order for such a seal arrangement to be securely fixed, a groove-shaped receiving space for the seal arrangement is frequently provided in the housing.

In the seal arrangements known from the prior art, it is disadvantageous that the housing bore or the groove-shaped receiving space is in contact with the medium to be sealed and that a dead space can result, in which there remains medium to be sealed. Seal arrangements of this type are therefore not suitable for use in food technology.

The same problem also arises when using known radial shaft sealing rings for rotary applications. These result, for example, in an annular dead space between the support ring and sealing lip. Moreover, such radial shaft sealing rings are only suitable under certain conditions if pressure is applied.

### SUMMARY

In an embodiment, the present invention provides a seal arrangement, comprising: a first sealing element, which is radially pre-loaded and rests against and seals a machine element; and a second sealing element, which is arranged concentrically to the first sealing element and radially presses the first sealing element against the machine element, wherein the first sealing element and the second sealing element are received in a housing bore of a housing, wherein the first sealing element and the second sealing element seal a gap between the housing bore and the machine element, and wherein the first sealing element and the second sealing element are configured to be flat in a radial plane, at least on an end face facing a space to be sealed, and aligned with each other.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 shows a seal arrangement with return structure;

FIG. 2 shows a seal arrangement with protective lip;

FIG. 3 shows a seal arrangement with a positive-locking connection between the first sealing element and second sealing element; and

FIG. 4 shows a seal arrangement in the form of a rod seal.

### DETAILED DESCRIPTION

In an embodiment, the present invention provides a seal arrangement which is suitable for use in food technology and has a good sealing effect.

The seal arrangement comprises a first sealing element, which is radially pre-loaded and rests against and seals a machine element, and a second sealing element, which is arranged concentrically to the first sealing element and radially presses the first sealing element against the first machine element, wherein the first sealing element and the second sealing element are received in a housing bore, wherein the first sealing element and the second sealing element seal the gap between the housing bore and the machine element, wherein the first sealing element and the second sealing element are configured to be flat in a radial plane, at least on the end face facing the space to be sealed, and aligned with each other and thereby form a flat surface free of dead space.

The first sealing element and the second sealing element are arranged in such a way that they can be received by a housing bore. It is not necessary to provide a groove-shaped receiving space in the housing. The gap which results between the housing bore and the machine element is filled by the first sealing element and the second sealing element in such a way that no medium to be sealed can penetrate into the gap between the housing bore and the machine element. Thus, the seal arrangement according to the invention is particularly suitable for use in food technology.

The first sealing element and/or the second sealing element can be of essentially cylindrical design. In cooperation with a cylindrically configured housing bore, this gives rise to the advantage that, after being mounted in the housing bore, the first sealing element and the second sealing element fill the housing bore in such a way that no medium to be sealed can penetrate into the housing bore. In particular, it is advantageous here that no dead space is produced, in which medium to be sealed can remain.

The end faces of the first sealing element and second sealing element facing the space to be sealed are preferably circular. This results in a flat, planar surface relative to the space to be sealed with the medium to be sealed, which surface is formed by the first sealing element and the second sealing element. In this embodiment, no dead spaces are formed in which medium to be sealed can remain. The housing bore is closed by the first sealing element and the second sealing element in such a way that no medium to be sealed can penetrate.

A seal arrangement designed in this way is particularly suitable for clean-in-place cleaning (CIP cleaning). In a CIP cleaning, the components of a food technology installation, such as the seal arrangement, are cleaned in place—without disassembly. The seal arrangement according to the invention is particularly suitable for such a CIP cleaning, because no cleaning agent or product residue can remain in dead spaces such as gaps or grooves.

A further improvement, especially from a hygienic point of view, results if the housing bore of the housing is aligned with the end faces of the sealing elements.

The first sealing element may be formed from polymeric material. A particularly suitable polymeric material is PTFE or a PTFE compound with fillers. PTFE has particularly low friction and is resistant to most media to be sealed, in particular most media to be sealed in the field of food technology. Furthermore, PTFE is resistant to the detergents used in CIP cleaning.

The second sealing element can be formed from an elastomeric material. The second sealing element thereby constantly presses the first sealing element against the machine element. Fluororubber is an advantageous elastomeric material for use in food technology. Similar to PTFE, fluororubber is resistant to most media and can moreover be used over a wide temperature spectrum.

The first sealing element can be connected to the second sealing element in a positive-locking manner. For this purpose, the first sealing element and the second sealing element can have a positive-locking geometry. For this purpose, the first sealing element can have, for example, a circumferential rectangular or sawtooth-shaped elevation and the second sealing element can have on its inner circumferential side an indentation congruent to the elevation of the first sealing element. The first sealing element and the second sealing element interlock with one another after assembly, so that they cannot unintentionally detach from one another. Such an embodiment is particularly advantageous when machine elements that undergo translational movement are to be sealed.

The first sealing element can be provided with a return structure on the inner circumferential side, that is to say, on the surface facing the machine element. The return structure is preferably designed in such a way that medium is conveyed back in the direction of the space to be sealed. The return geometry can be placed into the first sealing element in the form, for example, of a screw-shaped groove geometry.

The return geometry to the space to be sealed is preferably closed by a circumferential ridge. The circumferential ridge results in a static seal, so that, in particular during standstills, media can be prevented from flowing out of the space to be sealed.

The first sealing element can be supported at least in sections by the housing bore. This is advantageous in particular if the pressure on the medium side is higher, which could shear the first sealing element off from the second sealing element.

A protective lip may be formed from the second sealing element, which protrudes from the second sealing element in the radial and axial directions and which covers the first sealing element at least in sections. The protective lip protrudes in the direction of the environment.

The second sealing element may be tapered on the outer circumference side. The second sealing element is preferably conically tapered. This results in an annular compensating space with a triangular cross-section between the housing and the second sealing element. This space is not connected to the media space, so that, here as well, there is no dead space with medium to be sealed. The compensating space can compensate for thermal expansions and the swelling of the sealing elements caused by the action of media. This ensures that the first sealing element is constantly radially pressed against the machine element to be sealed. In order to empty the compensating space in the case of penetrating media—for example, due to a temporary leak at the dynamic sealing point—the compensating space can be connected to the environment via a channel.

The figures show a seal arrangement 1 comprising a first sealing element 2 and a second sealing element 4. The first sealing element 2 is radially pre-loaded and rests against and seals a machine element 3. The second sealing element 4 rests against the outer circumferential side of the first sealing element 2, wherein the second sealing element 4 is arranged concentrically with respect to the first sealing element 2 and radially presses the first sealing element 2 against the machine element 3.

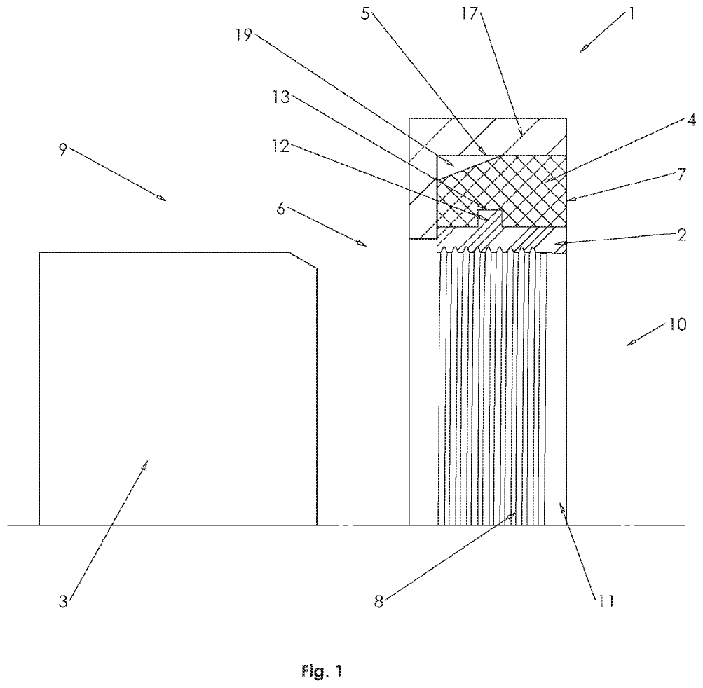

FIG. 1 shows a seal arrangement 1, with which the end faces 7 of the first sealing element 2 and second sealing element 4 facing the space 10 to be sealed are annular, so that the sealing elements 2, 4 are flat in a radial plane and are aligned with one another. This shape results in a planar and therefore particularly small and closed surface of the seal arrangement 1 facing the space 10 to be sealed. The surface is flat and free of dead space. As a result, the seal arrangement 1 can be cleaned particularly easily, a minimal area of contact with media results, and the seal arrangement 1 can be cleaned by means of CIP cleaning.

In the present case, the sealing elements 2, 4 also align at the end face facing the environment 9.

The first sealing element 2 is formed from a polymeric material, here PTFE, and the second sealing element 4 is formed from an elastomeric material, here a fluororubber.

The second sealing element 4 is radially pre-loaded and rests against the first sealing element 2. Moreover, the first sealing element 2 is connected to the second sealing element 4 in a positive-locking manner. To this end, the first sealing element 2 has on its outer circumference a rectangular projection 12 projecting in a manner radially outwards. The second sealing element 4 has a recess 13 congruent with respect to the projection 12 in the form of a rectangular groove. After assembly, the projection 12 interlocks with the recess 13, so that the first sealing element 2 and the second sealing element 4 are connected to one another in a captive manner.

The first sealing element 2 is provided on its inner circumferential side with a return structure 8 on the side facing the machine element 3. In the present case, the return structure 8 is shaped like a screw thread. To form the return structure 8, a spiral groove is introduced into the first sealing element 2. Here, the return structure 8 is formed in such a way that medium is conveyed in the direction of the space 10 to be sealed. A seal arrangement 1 thus equipped with a return structure 8 is particularly suitable for sealing machine elements 3 that undergo rotational movement.

In the direction of the space 10 to be sealed, the return structure 8 is closed by a circumferential ridge 11. This results in a static seal.

The second sealing element 4 has a recess 19 with a triangular cross-section extending along its outer circumferential side. This results in a compensating space between the housing 17 and the second sealing element 4. Changes in the volume of the sealing elements 2, 4 can be compensated for by the compensating space.

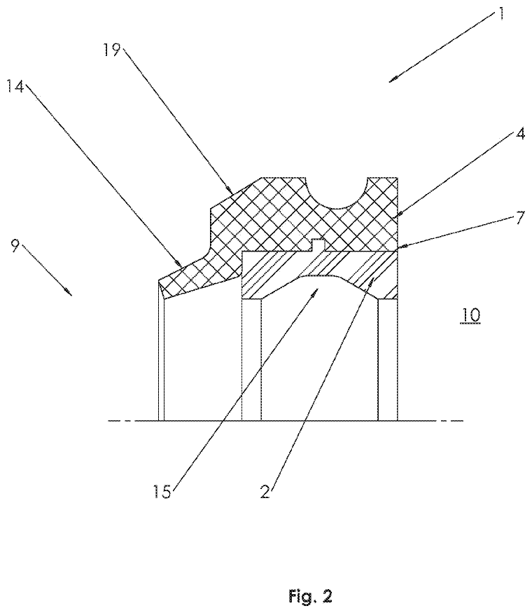

FIG. 2 shows a seal arrangement 1. In the present embodiment, a protective lip 14 is formed from the second sealing element 4. The protective lip 14 projects in the direction of the environment side 9 and at least partially covers the first sealing element 2.

The first sealing element 2 has a trapezoidal recess 15 on the side facing the machine element 3. This causes sealing lips to form on the two end faces of the first sealing element 2, which are under defined radial pre-loading and rest against the machine element 3. A sealing arrangement 1 of this type is particularly suitable for sealing machine elements 3 that undergo translational movement.

The protective lip 14 can be designed such that it comes to rest against the machine element 3. The protective lip 14 prevents dirt and the like from being able to penetrate into the gap between the first sealing element 2 and the machine element 3.

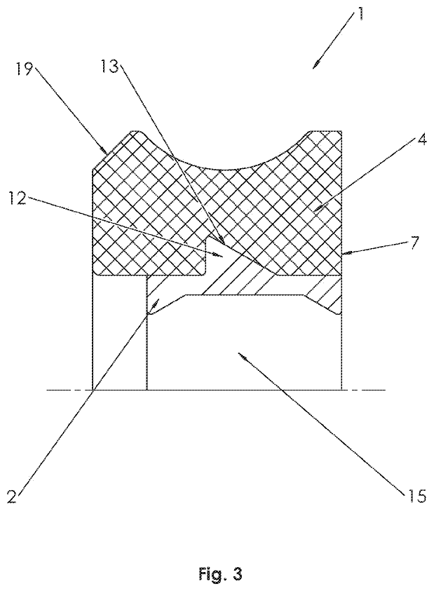

FIG. 3 shows a seal arrangement 1, with which the first sealing element 2 is connected to the second sealing element 4 in a positive-locking manner. In the present embodiment, the projection 12 and the recess 13 are sawtooth-shaped. The first sealing element 2 has a trapezoidal recess 15 on the side facing the machine element 3, so that sealing lips are formed in the region of the two end faces of the first sealing element 2, which are radially pre-loaded and rest against the machine element 3.

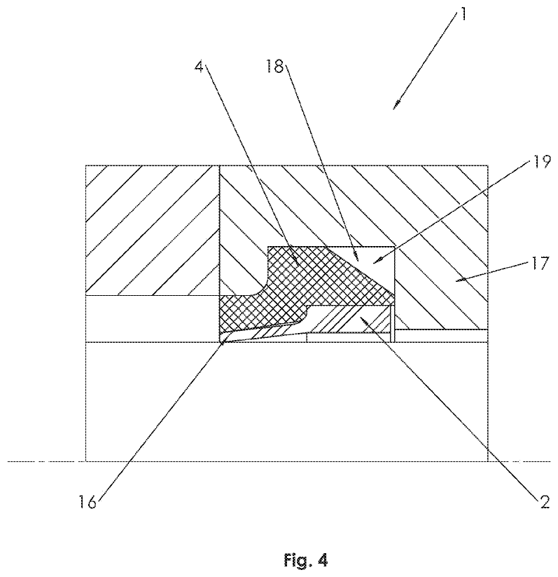

FIG. 4 shows a seal arrangement 1, which is designed as a rod seal and seals machine elements 3 that undergo translation motion. The first sealing element 2 has a lip seal 16 projecting in the direction of the space 10 to be sealed. Furthermore, a groove-shaped receiving space 18, in which the first sealing element 2 and the second sealing element 4 are received, is provided in the housing 17.

The second sealing element 4 has on its outer circumference a triangular further recess 19, so that the second sealing element 4 can extend into the region of the further recess 19 if high temperatures or swelling effects occur.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A seal arrangement comprising:
a first sealing element, which is radially pre-loaded and rests against and seals a machine element; and
a second sealing element, which is arranged concentrically to the first sealing element and radially presses the first sealing element against the machine element,
wherein the first sealing element and the second sealing element are received in a housing bore of a housing,
wherein the first sealing element and the second sealing element seal a gap between the housing bore and the machine element, and
characterized in thatwherein the first sealing element and the second sealing element are configured to be flat in a radial plane, at least on an end face facing a space to be sealed, and aligned with each other.

2. The seal arrangement according to claim 1, wherein end faces of the first sealing element and second sealing element facing the space to be sealed are annular.

3. The seal arrangement according to claim 1, wherein the first sealing element comprises a polymeric material.

4. The seal arrangement according to claim 1, wherein the second sealing element comprises an elastomeric material.

5. The seal arrangement according to claim 1, wherein the first sealing element is connected to the second sealing element in a positive-locking manner.

6. The seal arrangement according to claim 1, wherein the first sealing element comprises a return structure.

7. The seal arrangement according to claim 6, wherein the return structure is configured to convey medium in a direction of the space to be sealed.

8. The seal arrangement according to claim 6, wherein the return structure is closed in a direction of the space to be sealed by a circumferential ridge.

9. The seal arrangement according to claim 1, wherein the first sealing element is supported at least in sections in an axial direction on the housing bore.

10. The seal arrangement according to claim 1, wherein the housing and the second sealing element define a compensating space.

11. A method of using the seal arrangement according to claim 1 to seal machine elements in food technology installations.
